(19) United States
(12) Patent Application Publication
(10) Pub. No.: US 2013/0093189 A1
(43) Pub. Date: Apr. 18, 2013

(54) METHOD FOR GENERATING ADDITIONAL ELECTRIC ENERGY IN ELECTRIC BOATS

(71) Applicant: JAE HYUN LIM, CRESSKILL, NJ (US)

(72) Inventor: JAE HYUN LIM, CRESSKILL, NJ (US)

(21) Appl. No.: 13/442,079

(22) Filed: Apr. 9, 2012

(51) Int. Cl. H02K 13/00

(52) U.S. Cl. CPC H02K 13/00
USPC 290/50

(57) ABSTRACT

Disclosed is a method to create an extra electric energy source to power electric batteries while the electric boat is in motion. This electric energy source is generated from a separate installed component (a specially designed generator). This component converts the rotational energy from a transmission or propeller shaft through a delivery device.

### BACKGROUND OF THE INVENTION

With the rising costs of fossil fuels, there has been a hiking demand for renewable energy and many technological improvements have been developed to address this issue. With these renewable energy technology developments, many people have switched from conventional boats powered by fossil fuels to boats that run with renewable energy, such as electric boats, to reduce carbon dioxide emissions. The main advantages of electric boats are that they are environmentally friendly and require relatively simple maintenance.

### BRIEF SUMMARY OF THE INVENTION

This method presents an additional renewable energy source for recharging batteries installed in electric boats in motion. This is done by withdrawing rotational energy from the transmission or propeller shaft to a specially designed generator installed onto the boat infrastructure.

The key concept of this method is that the mechanical rotational energy from the transmission or propeller shaft is converted to electric energy while the boat is in motion, which recharges the batteries. This is a way to continuously supply a recharging source of electricity, which would increase the battery usage ratio per full battery charge. This would offer significant performance benefits in mileage per complete battery charge and make electric boats more reliable.

### BRIEF DESCRIPTION OF DRAWINGS

This method can be clearly explained with reference to the following drawings:

FIG. 1 is an illustration of the delivery device connecting the rotating transmission shaft to the main shaft of the installed specially designed generator.

FIG. 2 is a cross sectional view of the specially designed generator.

FIG. 3 is an illustration of an electric boat's recharging system in accordance to the present method.

### DETAILED DESCRIPTION OF THE INVENTION

The electric boat's batteries supply power to rotate the transmission or propeller shaft, which all work to move the boat by rotating the propeller.

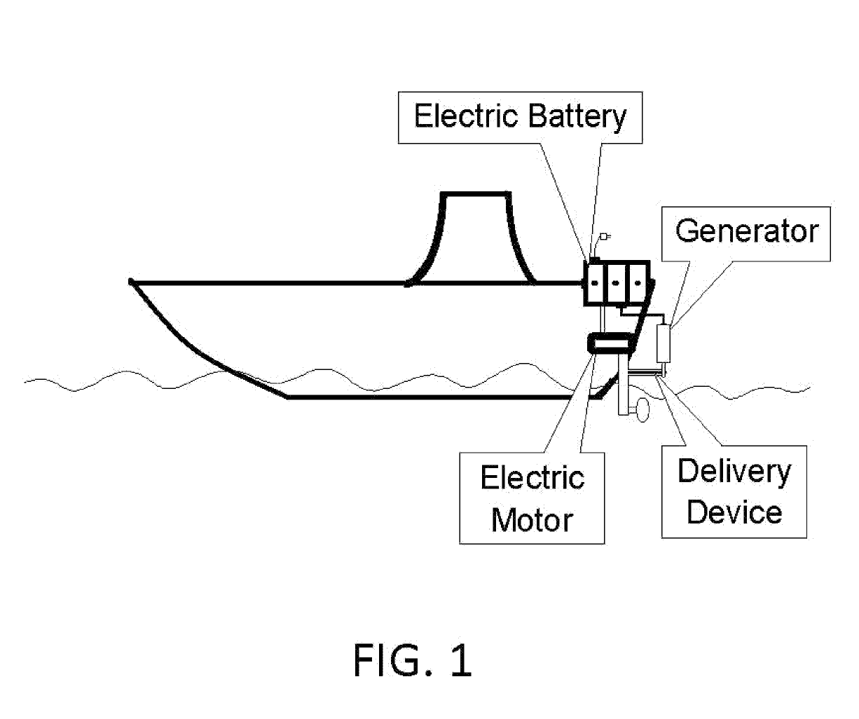

The delivery device in FIG. 1 transfers the rotational energy from the transmission or propeller shaft to the specially designed generator's main shaft. This delivery device can be composed of a belt, chain, gears, or any other suitable material.

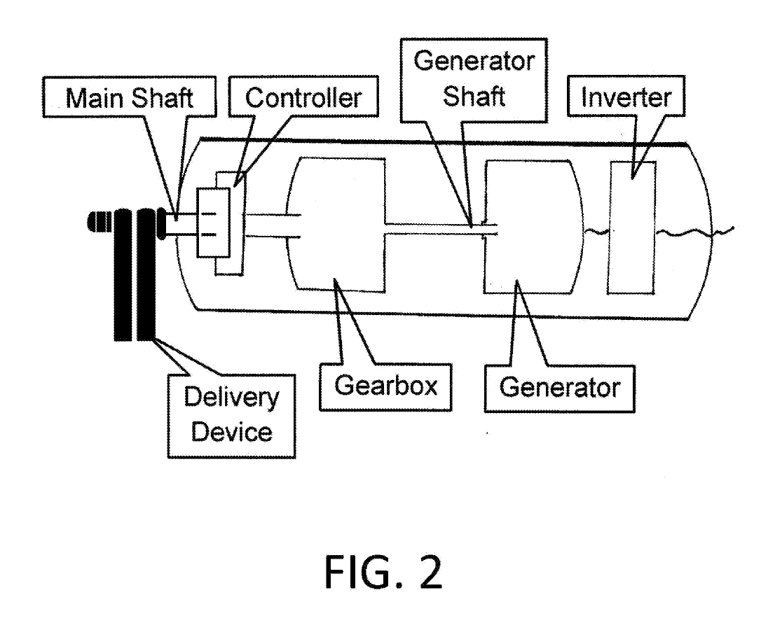

The specially designed generator shown in FIG. 2 consists of a controller, a gearbox, a generator, and an inverter. The controller consists of a brake system and a sensor. The brake system manages the rotational speed of the main shaft, which depends on the operator's driving patterns. The sensor regulates the temperature of the generator by adjusting the brake system to control the rotational speed of the main shaft. The gearbox transfers the rotational velocity of the main shaft to the generator shaft which would result in a controlled rotational velocity. The generator converts the mechanical rotational energy of the generator shaft to electrical energy. Then, the electrical energy, through the inverter, recharges the electric batteries.

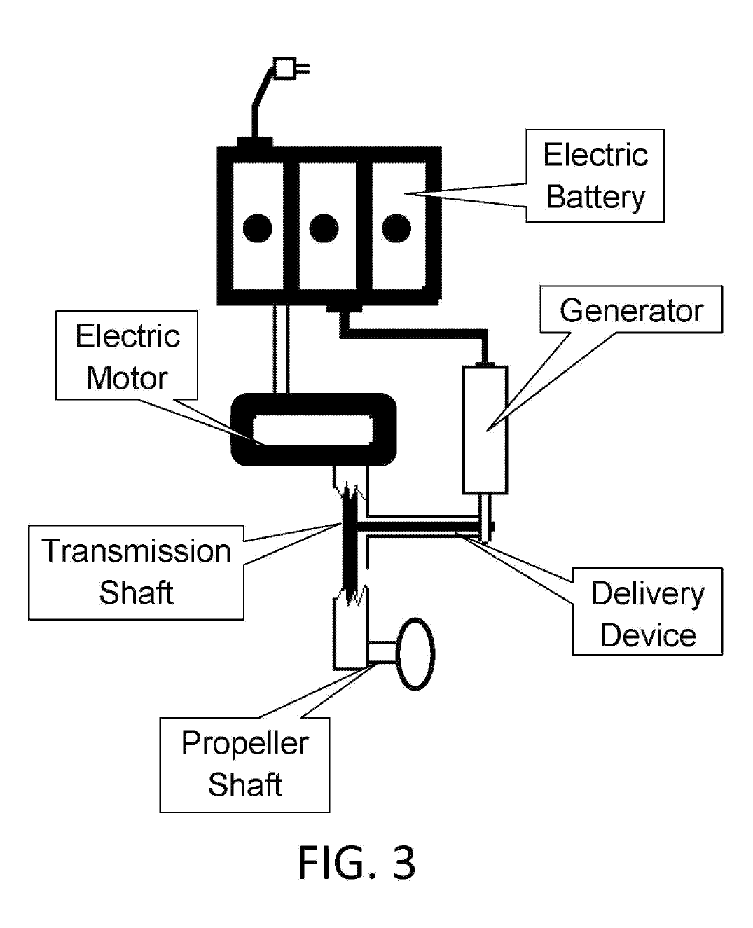

FIG. 3 illustrates the recharging system of this method: the rotating transmission or propeller shaft delivers the rotational energy to the main shaft of the generator through the delivery device, in which the resulting electric energy from the generator recharges the batteries, in which then supplies electric power to the motor.

What is claimed is:

1. A method to generate an extra electric energy source to recharge the batteries of electric boats in motion by withdrawing the rotational energy from the transmission or propeller shaft to power a separate generator through a delivery device.
